(19) United States
(12) Patent Application Publication
(10) Pub. No.: US 2014/0142935 A1
(43) Pub. Date: May 22, 2014

(54) User-Specific Noise Suppression for Voice Quality Improvements

(71) Applicant: Apple Inc., Cupertino, CA (US)

(72) Inventors: Aram Lindahl, Menlo Park, CA (US); Baptiste Pierre Paquier, Saratoga, CA (US)

(73) Assignee: Apple Inc., Cupertino, CA (US)

(21) Appl. No.: 14/165,523

(22) Filed: Jan. 27, 2014

Related U.S. Application Data
(63) Continuation of application No. 12/794,643, filed on Jun. 4, 2010, now Pat. No. 8,639,516.

(51) Int. Cl. G10L 21/0208

(52) U.S. Cl. CPC G10L 21/0208
USPC 704/226

(57) ABSTRACT

Systems, methods, and devices for user-specific noise suppression are provided. For example, when a voice-related feature of an electronic device is in use, the electronic device may receive an audio signal that includes a user voice. Since noise, such as ambient sounds, also may be received by the electronic device at this time, the electronic device may suppress such noise in the audio signal. In particular, the electronic device may suppress the noise in the audio signal while substantially preserving the user voice via user-specific noise suppression parameters. These user-specific noise suppression parameters may be based at least in part on a user noise suppression preference or a user voice profile, or a combination thereof.

### RELATED APPLICATIONS

This application is a continuation of U.S. application Ser. No. 12/794,643, filed Jun. 4, 2010, which application is incorporated by reference herein in its entirety.

### BACKGROUND

The present disclosure relates generally to techniques for noise suppression and, more particularly, for user-specific noise suppression.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Many electronic devices employ voice-related features that involve recording and/or transmitting a user's voice. Voice note recording features, for example, may record voice notes spoken by the user. Similarly, a telephone feature of an electronic device may transmit the user's voice to another electronic device. When an electronic device obtains a user's voice, however, ambient sounds or background noise may be obtained at the same time. These ambient sounds may obscure the user's voice and, in some cases, may impede the proper functioning of a voice-related feature of the electronic device.

To reduce the effect of ambient sounds when a voice-related feature is in use, electronic devices may apply a variety of noise suppression schemes. Device manufactures may program such noise suppression schemes to operate according to certain predetermined generic parameters calculated to be well-received by most users. However, certain voices may be less well suited for these generic noise suppression parameters. Additionally, some users may prefer stronger or weaker noise suppression.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Embodiments of the present disclosure relate to systems, methods, and devices for user-specific noise suppression. For example, when a voice-related feature of an electronic device is in use, the electronic device may receive an audio signal that includes a user voice. Since noise, such as ambient sounds, also may be received by the electronic device at this time, the electronic device may suppress such noise in the audio signal. In particular, the electronic device may suppress the noise in the audio signal while substantially preserving the user voice via user-specific noise suppression parameters. These user-specific noise suppression parameters may be based at least in part on a user noise suppression preference or a user voice profile, or a combination thereof.

### BRIEF DESCRIPTION OF THE DRAWINGS

Various aspects of this disclosure may be better understood upon reading the following detailed description and upon reference to the drawings in which:

FIG. 1 is a block diagram of an electronic device capable of performing the techniques disclosed herein, in accordance with an embodiment;

FIG. 2 is a schematic view of a handheld device representing one embodiment of the electronic device of FIG. 1;

FIG. 3 is a schematic block diagram representing various context in which a voice-related feature of the electronic device of FIG. 1 may be used, in accordance with an embodiment;

FIG. 4 is a block diagram of noise suppression that may take place in the electronic device of FIG. 1, in accordance with an embodiment;

FIG. 5 is a block diagram representing user-specific noise suppression parameters, in accordance with an embodiment;

FIG. 6 is a flow chart describing an embodiment of a method for applying user-specific noise suppression parameters in the electronic device of FIG. 1;

FIG. 7 is a schematic diagram of the initiation of a voice training sequence when the handheld device of FIG. 2 is activated, in accordance with an embodiment;

FIG. 8 is a schematic diagram of a series of screens for selecting the initiation of a voice training sequence using the handheld device of FIG. 2, in accordance with an embodiment;

FIG. 9 is a flowchart describing an embodiment of a method for determining user-specific noise suppression parameters via a voice training sequence;

FIGS. 10 and 11 are schematic diagrams for a manner of obtaining a user voice sample for voice training, in accordance with an embodiment;

FIG. 12 is a schematic diagram illustrating a manner of obtaining a noise suppression user preference during a voice training sequence, in accordance with an embodiment;

FIG. 13 is a flowchart describing an embodiment of a method for obtaining noise suppression user preferences during a voice training sequence;

FIG. 14 is a flowchart describing an embodiment of another method for performing a voice training sequence;

FIG. 15 is a flowchart describing an embodiment of a method for obtaining a high signal-to-noise ratio (SNR) user voice sample;

FIG. 16 is a flowchart describing an embodiment of a method for determining user-specific noise suppression parameters via analysis of a user voice sample;

FIG. 17 is a factor diagram describing characteristics of a user voice sample that may be considered while performing the method of FIG. 16, in accordance with an embodiment;

FIG. 18 is a schematic diagram representing a series of screens that may be displayed on the handheld device of FIG. 2 to obtain a user-specific noise parameters via a user-selectable setting, in accordance with an embodiment;

FIG. 19 is a schematic diagram of a screen on the handheld device of FIG. 2 for obtaining user-specified noise suppression parameters in real-time while a voice-related feature of the handheld device is in use, in accordance with an embodiment;

FIGS. 20 and 21 are schematic diagrams representing various sub-parameters that may form the user-specific noise suppression parameters, in accordance with an embodiment;

FIG. 22 is a flowchart describing an embodiment of a method for applying certain sub-parameters of the user-specific parameters based on detected ambient sounds;

FIG. 23 is a flowchart describing an embodiment of a method for applying certain sub-parameters of the noise suppression parameters based on a context of use of the electronic device;

FIG. 24 is a factor diagram representing a variety of device context factors that may be employed in the method of FIG. 23, in accordance with an embodiment;

FIG. 25 is a flowchart describing an embodiment of a method for obtaining a user voice profile;

FIG. 26 is a flowchart describing an embodiment of a method for applying noise suppression based on a user voice profile;

FIGS. 27-29 are plots depicting a manner of performing noise suppression of an audio signal based on a user voice profile, in accordance with an embodiment;

FIG. 30 is a flowchart describing an embodiment of a method for obtaining user-specific noise suppression parameters via a voice training sequence involving per-recorded voices;

FIG. 31 is a flowchart describing an embodiment of a method for applying user-specific noise suppression parameters to audio received from another electronic device;

FIG. 32 is a flowchart describing an embodiment of a method for causing another electronic device to engage in noise suppression based on the user-specific noise parameters of a first electronic device, in accordance with an embodiment; and

FIG. 33 is a schematic block diagram of a system for performing noise suppression on two electronic devices based on user-specific noise suppression parameters associated with the other electronic device, in accordance with an embodiment.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Present embodiments relate to suppressing noise in an audio signal associated with a voice-related feature of an electronic device. Such a voice-related feature may include, for example, a voice note recording feature, a video recording feature, a telephone feature, and/or a voice command feature, each of which may involve an audio signal that includes a user's voice. In addition to the user's voice, however, the audio signal also may include ambient sounds present while the voice-related feature is in use. Since these ambient sounds may obscure the user's voice, the electronic device may apply noise suppression to the audio signal to filter out the ambient sounds while preserving the user's voice.

Rather than employ generic noise suppression parameters programmed at the manufacture of the device, noise suppression according to present embodiments may involve user-specific noise suppression parameters that may be unique to a user of the electronic device. These user-specific noise suppression parameters may be determined through voice training, based on a voice profile of the user, and/or based on a manually selected user setting. When noise suppression takes place based on user-specific parameters rather than generic parameters, the sound of the noise-suppressed signal may be more satisfying to the user. These user-specific noise suppression parameters may be employed in any voice-related feature, and may be used in connection with automatic gain control (AGC) and/or equalization (EQ) tuning.

As noted above, the user-specific noise suppression parameters may be determined using a voice training sequence. In such a voice training sequence, the electronic device may apply varying noise suppression parameters to a user's voice sample mixed with one or more distractors (e.g., simulated ambient sounds such as crumpled paper, white noise, babbling people, and so forth). The user may thereafter indicate which noise suppression parameters produce the most preferable sound. Based on the user's feedback, the electronic device may develop and store the user-specific noise suppression parameters for later use when a voice-related feature of the electronic device is in use.

Additionally or alternatively, the user-specific noise suppression parameters may be determined by the electronic device automatically depending on characteristics of the user's voice. Different users' voices may have a variety of different characteristics, including different average frequencies, different variability of frequencies, and/or different distinct sounds. Moreover, certain noise suppression parameters may be known to operate more effectively with certain voice characteristics. Thus, an electronic device according to certain present embodiments may determine the user-specific noise suppression parameters based on such user voice characteristics. In some embodiments, a user may manually set the noise suppression parameters by, for example, selecting a high/medium/low noise suppression strength selector or indicating a current call quality on the electronic device.

When the user-specific parameters have been determined, the electronic device may suppress various types of ambient sounds that may be heard while a voice-related feature is being used. In certain embodiments, the electronic device may analyze the character of the ambient sounds and apply a user-specific noise suppression parameter that is expected to thus suppress the current ambient sounds. In another embodiment, the electronic device may apply certain user-specific noise suppression parameters based on the current context in which the electronic device is being used.

In certain embodiments, the electronic device may perform noise suppression tailored to the user based on a user voice profile associated with the user. Thereafter, the electronic device may more effectively isolate ambient sounds from an audio signal when a voice-related feature is being used because the electronic device generally may expect which components of an audio signal correspond to the user's voice. For example, the electronic device may amplify components of an audio signal associated with a user voice profile while suppressing components of the audio signal not associated with the user voice profile.

User-specific noise suppression parameters also may be employed to suppress noise in audio signals containing voices other than that of the user that are received by the electronic device. For example, when the electronic device is used for a telephone or chat feature, the electronic device may employ the user-specific noise suppression parameters to an audio signal from a person with whom the user is corresponding. Since such an audio signal may have been previously processed by the sending device, such noise suppression may be relatively minor. In certain embodiments, the electronic device may transmit the user-specific noise suppression parameters to the sending device, so that the sending device may modify its noise suppression parameters accordingly. In the same way, two electronic devices may function systematically to suppress noise in outgoing audio signals according to each other's user-specific noise suppression parameters.

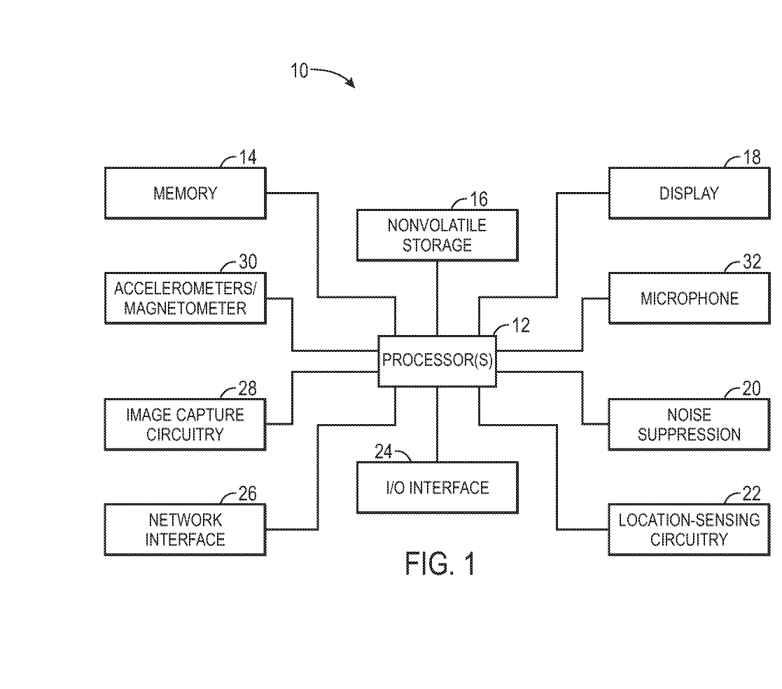

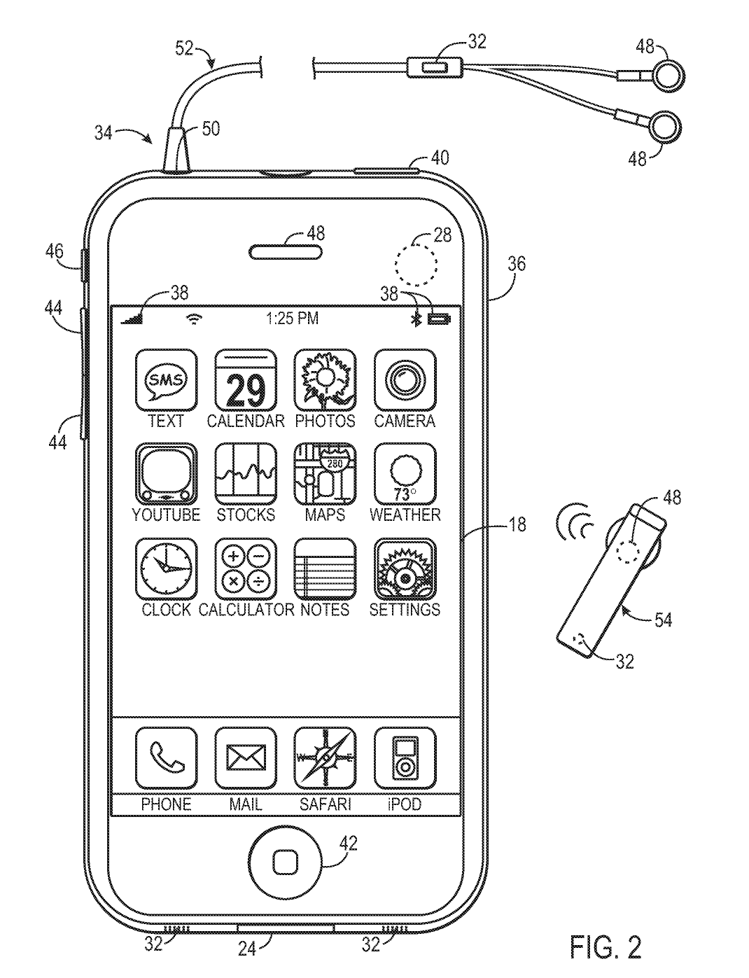

With the foregoing in mind, a general description of suitable electronic devices for performing the presently disclosed techniques is provided below. In particular, FIG. 1 is a block diagram depicting various components that may be present in an electronic device suitable for use with the present techniques. FIG. 2 represents one example of a suitable electronic device, which may be, as illustrated, a handheld electronic device having noise suppression capabilities.

Turning first to FIG. 1, an electronic device 10 for performing the presently disclosed techniques may include, among other things, one or more processor(s) 12, memory 14, nonvolatile storage 16, a display 18, noise suppression 20, location-sensing circuitry 22, an input/output (I/O) interface 24, network interfaces 26, image capture circuitry 28, accelerometers/magnetometer 30, and a microphone 32. The various functional blocks shown in FIG. 1 may include hardware elements (including circuitry), software elements (including computer code stored on a computer-readable medium) or a combination of both hardware and software elements. It should further be noted that FIG. 1 is merely one example of a particular implementation and is intended to illustrate the types of components that may be present in electronic device 10.

By way of example, the electronic device 10 may represent a block diagram of the handheld device depicted in FIG. 2 or similar devices. Additionally or alternatively, the electronic device 10 may represent a system of electronic devices with certain characteristics. For example, a first electronic device may include at least a microphone 32, which may provide audio to a second electronic device including the processor(s) 12 and other data processing circuitry. It should be noted that the data processing circuitry may be embodied wholly or in part as software, firmware, hardware or any combination thereof. Furthermore the data processing circuitry may be a single contained processing module or may be incorporated wholly or partially within any of the other elements within electronic device 10. The data processing circuitry may also be partially embodied within electronic device 10 and partially embodied within another electronic device wired or wirelessly connected to device 10. Finally, the data processing circuitry may be wholly implemented within another device wired or wirelessly connected to device 10. As a non-limiting example, data processing circuitry might be embodied within a headset in connection with device 10.

In the electronic device 10 of FIG. 1, the processor(s) 12 and/or other data processing circuitry may be operably coupled with the memory 14 and the nonvolatile memory 16 to perform various algorithms for carrying out the presently disclosed techniques. Such programs or instructions executed by the processor(s) 12 may be stored in any suitable manufacture that includes one or more tangible, computer-readable media at least collectively storing the instructions or routines, such as the memory 14 and the nonvolatile storage 16. Also, programs (e.g., an operating system) encoded on such a computer program product may also include instructions that may be executed by the processor(s) 12 to enable the electronic device 10 to provide various functionalities, including those described herein. The display 18 may be a touch-screen display, which may enable users to interact with a user interface of the electronic device 10.

The noise suppression 20 may be performed by data processing circuitry such as the processor(s) 12 or by circuitry dedicated to performing certain noise suppression on audio signals processed by the electronic device 10. For example, the noise suppression 20 may be performed by a baseband integrated circuit (IC), such as those manufactured by Infineon, based on externally provided noise suppression parameters. Additionally or alternatively, the noise suppression 20 may be performed in a telephone audio enhancement integrated circuit (IC) configured to perform noise suppression based on externally provided noise suppression parameters, such as those manufactured by Audience. These noise suppression ICs may operate at least partly based on certain noise suppression parameters. Varying such noise suppression parameters may vary the output of the noise suppression 20.

The location-sensing circuitry 22 may represent device capabilities for determining the relative or absolute location of electronic device 10. By way of example, the location-sensing circuitry 22 may represent Global Positioning System (GPS) circuitry, algorithms for estimating location based on proximate wireless networks, such as local Wi-Fi networks, and so forth. The I/O interface 24 may enable electronic device 10 to interface with various other electronic devices, as may the network interfaces 26. The network interfaces 26 may include, for example, interfaces for a personal area network (PAN), such as a Bluetooth network, for a local area network (LAN), such as an 802.11x Wi-Fi network, and/or for a wide area network (WAN), such as a 3G cellular network. Through the network interfaces 26, the electronic device 10 may interface with a wireless headset that includes a microphone 32. The image capture circuitry 28 may enable image and/or video capture, and the accelerometers/magnetometer 30 may observe the movement and/or a relative orientation of the electronic device 10.

When employed in connection with a voice-related feature of the electronic device 10, such as a telephone feature or a voice recognition feature, the microphone 32 may obtain an audio signal of a user's voice. Though ambient sounds may also be obtained in the audio signal in addition to the user's voice, the noise suppression 20 may process the audio signal to exclude most ambient sounds based on certain user-specific noise suppression parameters. As described in greater detail below, the user-specific noise suppression parameters may be determined through voice training, based on a voice profile of the user, and/or based on a manually selected user setting.

FIG. 2 depicts a handheld device 34, which represents one embodiment of the electronic device 10. The handheld device 34 may represent, for example, a portable phone, a media player, a personal data organizer, a handheld game platform, or any combination of such devices. By way of example, the handheld device 34 may be a model of an iPod® or iPhone® available from Apple Inc. of Cupertino, Calif.

The handheld device 34 may include an enclosure 36 to protect interior components from physical damage and to shield them from electromagnetic interference. The enclosure 36 may surround the display 18, which may display indicator icons 38. The indicator icons 38 may indicate, among other things, a cellular signal strength, Bluetooth connection, and/or battery life. The I/O interfaces 24 may open through the enclosure 36 and may include, for example, a proprietary I/O port from Apple Inc. to connect to external devices. As indicated in FIG. 2, the reverse side of the handheld device 34 may include the image capture circuitry 28.

User input structures 40, 42, 44, and 46, in combination with the display 18, may allow a user to control the handheld device 34. For example, the input structure 40 may activate or deactivate the handheld device 34, the input structure 42 may navigate user interface 20 to a home screen, a user-configurable application screen, and/or activate a voice-recognition feature of the handheld device 34, the input structures 44 may provide volume control, and the input structure 46 may toggle between vibrate and ring modes. The microphone 32 may obtain a user's voice for various voice-related features, and a speaker 48 may enable audio playback and/or certain phone capabilities. Headphone input 50 may provide a connection to external speakers and/or headphones.

As illustrated in FIG. 2, a wired headset 52 may connect to the handheld device 34 via the headphone input 50. The wired headset 52 may include two speakers 48 and a microphone 32. The microphone 32 may enable a user to speak into the handheld device 34 in the same manner as the microphones 32 located on the handheld device 34. In some embodiments, a button near the microphone 32 may cause the microphone 32 to awaken and/or may cause a voice-related feature of the handheld device 34 to activate. A wireless headset 54 may similarly connect to the handheld device 34 via a wireless interface (e.g., a Bluetooth interface) of the network interfaces 26. Like the wired headset 52, the wireless headset 54 may also include a speaker 48 and a microphone 32. Also, in some embodiments, a button near the microphone 32 may cause the microphone 32 to awaken and/or may cause a voice-related feature of the handheld device 34 to activate. Additionally or alternatively, a standalone microphone 32 (not shown), which may lack an integrated speaker 48, may interface with the handheld device 34 via the headphone input 50 or via one of the network interfaces 26.

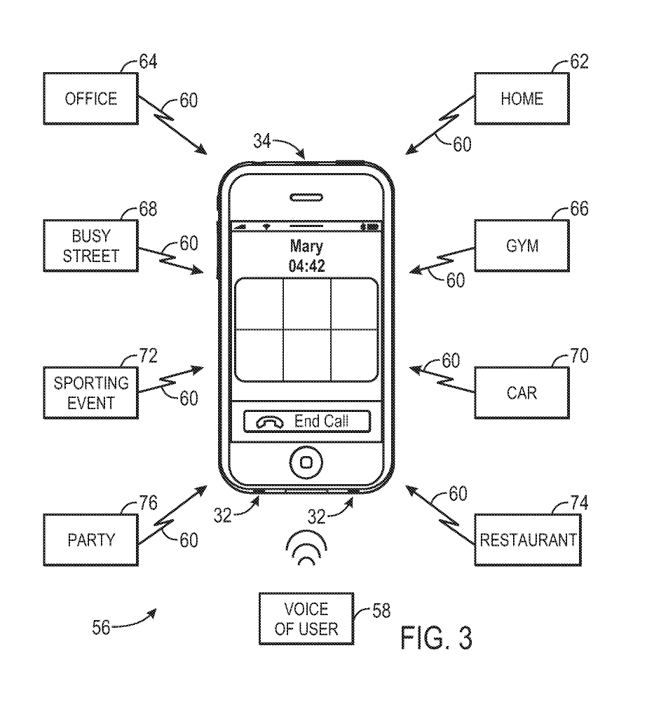

A user may use a voice-related feature of the electronic device 10, such as a voice-recognition feature or a telephone feature, in a variety of contexts with various ambient sounds. FIG. 3 illustrates many such contexts 56 in which the electronic device 10, depicted as the handheld device 34, may obtain a user voice audio signal 58 and ambient sounds 60 while performing a voice-related feature. By way of example, the voice-related feature of the electronic device 10 may include, for example, a voice recognition feature, a voice note recording feature, a video recording feature, and/or a telephone feature. The voice-related feature may be implemented on the electronic device 10 in software carried out by the processor(s) 12 or other processors, and/or may be implemented in specialized hardware.

When the user speaks the voice audio signal 58, it may enter the microphone 32 of the electronic device 10. At approximately the same time, however, ambient sounds 60 also may enter the microphone 32. The ambient sounds 60 may vary depending on the context 56 in which the electronic device 10 is being used. The various contexts 56 in which the voice-related feature may be used may include at home 62, in the office 64, at the gym 66, on a busy street 68, in a car 70, at a sporting event 72, at a restaurant 74, and at a party 76, among others. As should be appreciated, the typical ambient sounds 60 that occur on a busy street 68 may differ greatly from the typical ambient sounds 60 that occur at home 62 or in a car 70.

The character of the ambient sounds 60 may vary from context 56 to context 56. As described in greater detail below, the electronic device 10 may perform noise suppression 20 to filter the ambient sounds 60 based at least partly on user-specific noise suppression parameters. In some embodiments, these user-specific noise suppression parameters may be determined via voice training, in which a variety of different noise suppression parameters may be tested on an audio signal including a user voice sample and various distractors (simulated ambient sounds). The distractors employed in voice training may be chosen to mimic the ambient sounds 60 found in certain contexts 56. Additionally, each of the contexts 56 may occur at certain locations and times, with varying amounts of electronic device 10 motion and ambient light, and/or with various volume levels of the voice signal 58 and the ambient sounds 60. Thus, the electronic device 10 may filter the ambient sounds 60 using user-specific noise suppression parameters tailored to certain contexts 56, as determined based on time, location, motion, ambient light, and/or volume level, for example.

FIG. 4 is a schematic block diagram of a technique 80 for performing the noise suppression 20 on the electronic device 10 when a voice-related feature of the electronic device 10 is in use. In the technique 80 of FIG. 4, the voice-related feature involves two-way communication between a user and another person and may take place when a telephone or chat feature of the electronic device 10 is in use. However, it should be appreciated that the electronic device 10 also may perform the noise suppression 20 on an audio signal either received through the microphone 32 or the network interface 26 of the electronic device when two-way communication is not occurring.

In the noise suppression technique 80, the microphone 32 of the electronic device 10 may obtain a user voice signal 58 and ambient sounds 60 present in the background. This first audio signal may be encoded by a codec 82 before entering noise suppression 20. In the noise suppression 20, transmit noise suppression (TX NS) 84 may be applied to the first audio signal. The manner in which noise suppression 20 occurs may be defined by certain noise suppression parameters (illustrated as transmit noise suppression (TX NS) parameters 86) provided by the processor(s) 12, memory 14, or nonvolatile storage 16, for example. As discussed in greater detail below, the TX NS parameters 86 may be user-specific noise suppression parameters determined by the processor(s) 12 and tailored to the user and/or context 56 of the electronic device 10. After performing the noise suppression 20 at numeral 84, the resulting signal may be passed to an uplink 88 through the network interface 26.

A downlink 90 of the network interface 26 may receive a voice signal from another device (e.g., another telephone). Certain noise receiver noise suppression (RX NS) 92 may be applied to this incoming signal in the noise suppression 20. The manner in which such noise suppression 20 occurs may be defined by certain noise suppression parameters (illustrated as receive noise suppression (RX NS) parameters 94) provided by the processor(s) 12, memory 14, or nonvolatile storage 16, for example. Since the incoming audio signal previously may have been processed for noise suppression before leaving the sending device, the RX NS parameters 94 may be selected to be less strong than the TX NS parameters 86. The resulting noise-suppressed signal may be decoded by the codec 82 and output to receiver circuitry and/or a speaker 48 of the electronic device 10.

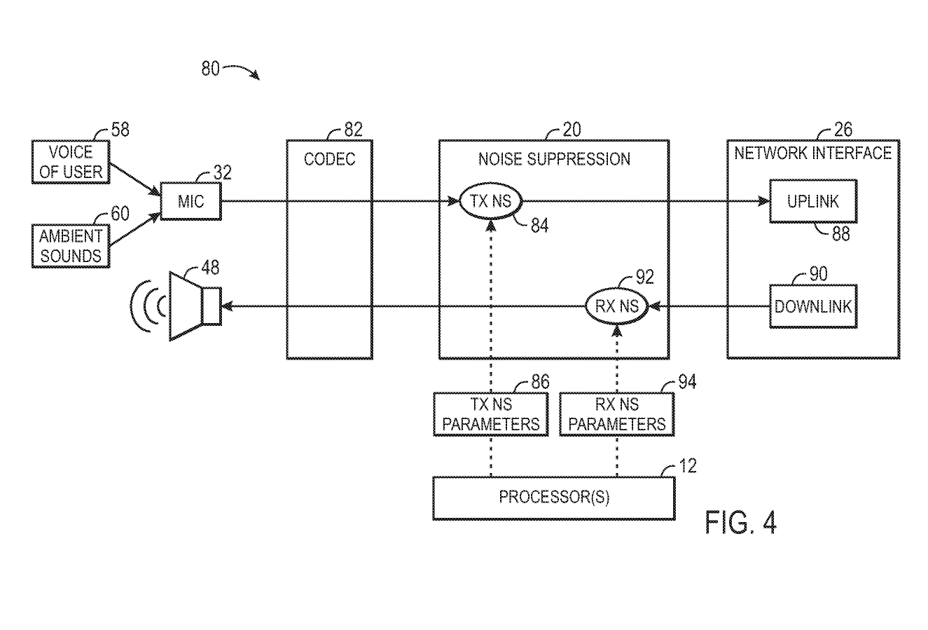

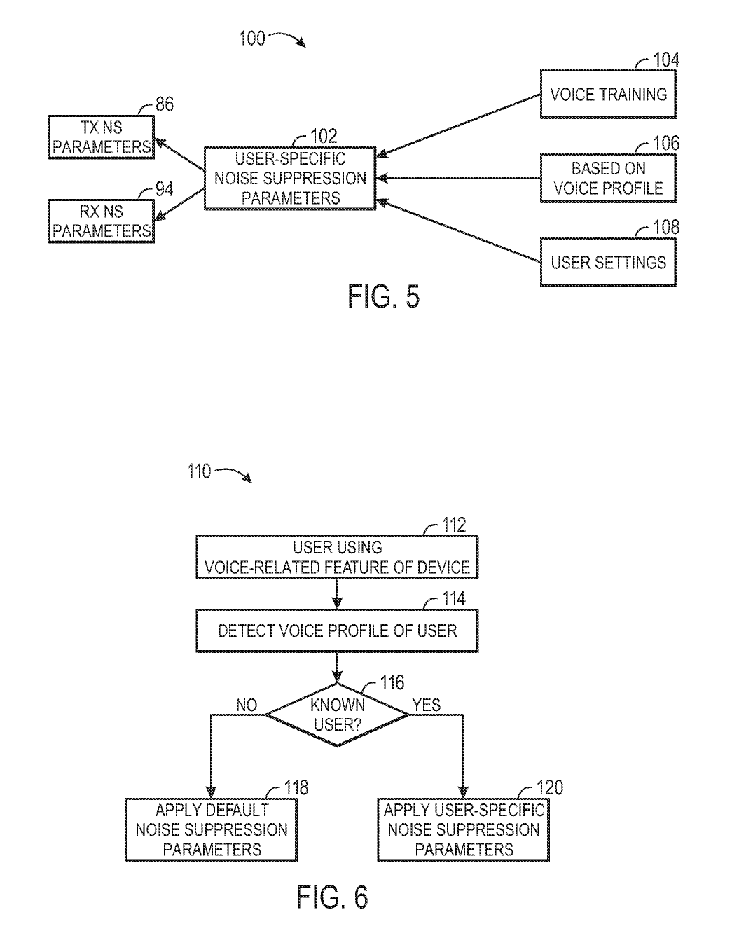

The TX NS parameters 86 and/or the RX NS parameters 94 may be specific to the user of the electronic device 10. That is, as shown by a diagram 100 of FIG. 5, the TX NS parameters 86 and the RX NS parameters 94 may be selected from user-specific noise suppression parameters 102 that are tailored to the user of the electronic device 10. These user-specific noise suppression parameters 102 may be obtained in a variety of ways, such as through voice training 104, based on a user voice profile 106, and/or based on user-selectable settings 108, as described in greater detail below.

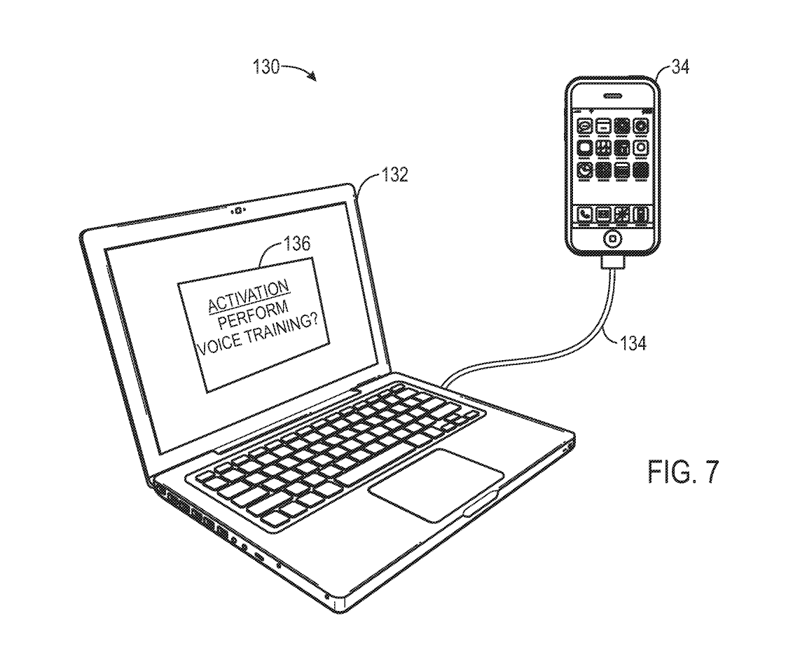

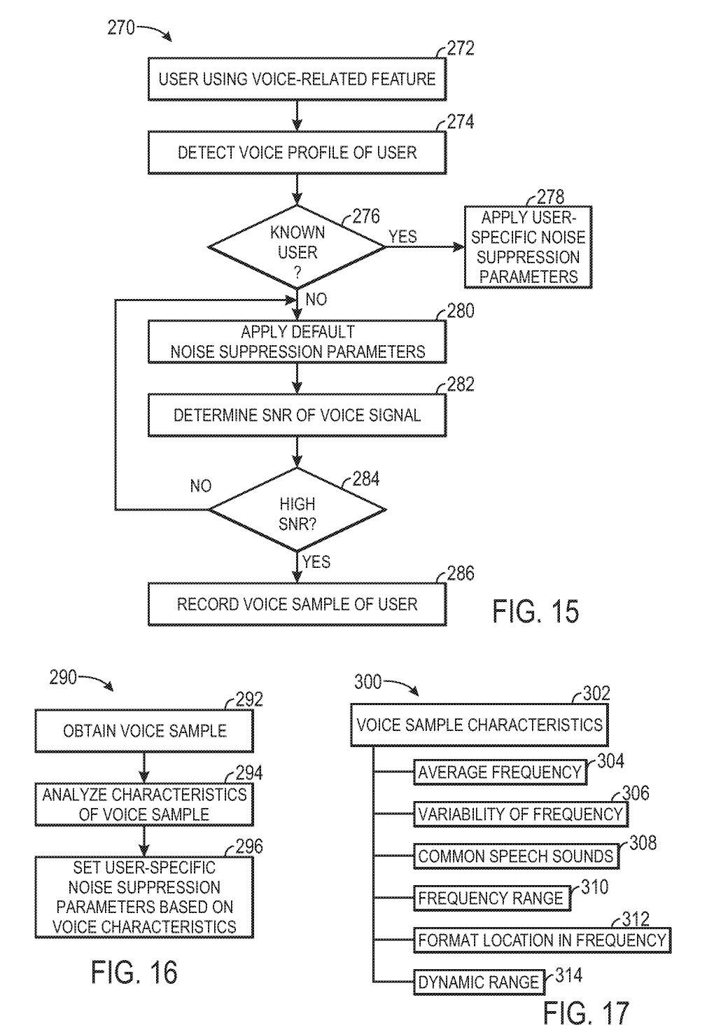

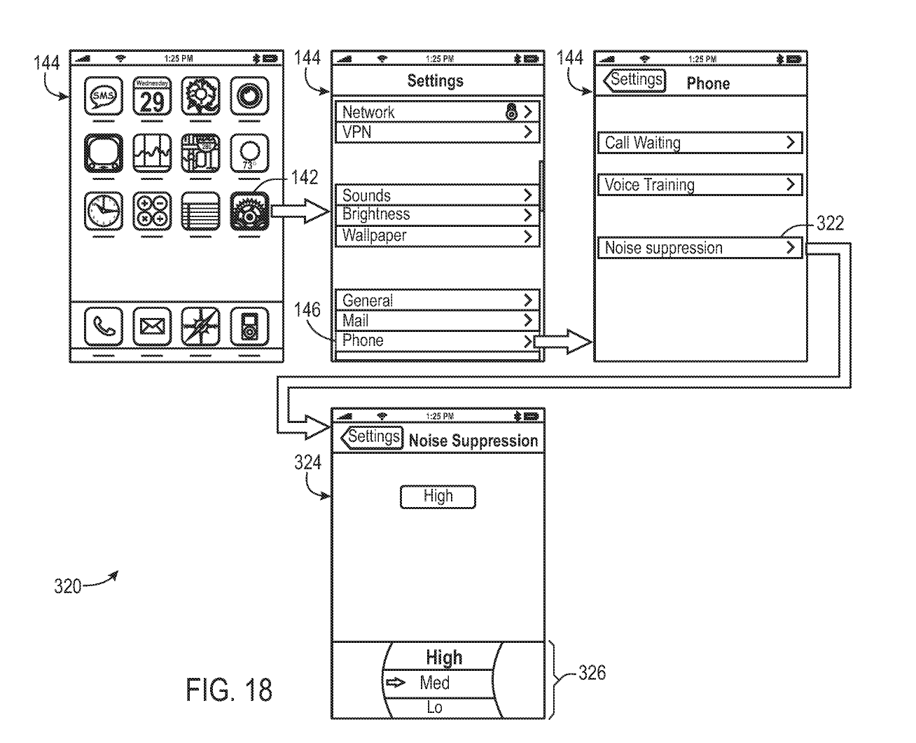

Voice training 104 may allow the electronic device 10 to determine the user-specific noise suppression parameters 102 by way of testing a variety of noise suppression parameters combined with various distractors or simulated background noise. Certain embodiments for performing such voice training 104 are discussed in greater detail below with reference to FIGS. 7-14. Additionally or alternatively, the electronic device 10 may determine the user-specific noise suppression parameters 102 based on a user voice profile 106 that may consider specific characteristics of the user's voice, as discussed in greater detail below with reference to FIGS. 15-17. Additionally or alternatively, a user may indicate preferences for the user-specific noise suppression parameters 102 through certain user settings 108, as discussed in greater detail below with reference to FIGS. 18 and 19. Such user-selectable settings may include, for example, a noise suppression strength (e.g., low/medium/high) selector and/or a real-time user feedback selector to provide user feedback regarding the user's real-time voice quality.

In general, the electronic device 10 may employ the user-specific noise suppression parameters 102 when a voice-related feature of the electronic device is in use (e.g., the TX NS parameters 86 and the RX NS parameters 94 may be selected based on the user-specific noise suppression parameters 102). In certain embodiments, the electronic device 10 may apply certain user-specific noise suppression parameters 102 during noise suppression 20 based on an identification of the user who is currently using the voice-related feature. Such a situation may occur, for example, when an electronic device 10 is used by other family members. Each member of the family may represent a user that may sometimes use a voice-related feature of the electronic device 10. Under such multi-user conditions, the electronic device 10 may ascertain whether there are user-specific noise suppression parameters 102 associated with that user.

For example, FIG. 6 illustrates a flowchart 110 for applying certain user-specific noise suppression parameters 102 when a user has been identified. The flowchart 110 may begin when a user is using a voice-related feature of the electronic device 10 (block 112). In carrying out the voice-related feature, the electronic device 10 may receive an audio signal that includes a user voice signal 58 and ambient sounds 60. From the audio signal, the electronic device 10 generally may determine certain characteristics of the user's voice and/or may identify a user voice profile from the user voice signal 58 (block 114). As discussed below, a user voice profile may represent information that identifies certain characteristics associated with the voice of a user.

If the voice profile detected at block 114 does not match any known users with whom user-specific noise suppression parameters 102 are associated (block 116), the electronic device 10 may apply certain default noise suppression parameters for noise suppression 20 (block 118). However, if the voice profile detected in block 114 does match a known user of the electronic device 10, and the electronic device 10 currently stores user-specific noise suppression parameters 102 associated with that user, the electronic device 10 may instead apply the associated user-specific noise suppression parameters 102 (block 120).

As mentioned above, the user-specific noise suppression parameters 102 may be determined based on a voice training sequence 104. The initiation of such a voice training sequence 104 may be presented as an option to a user during an activation phase 130 of an embodiment of the electronic device 10, such as the handheld device 34, as shown in FIG. 7. In general, such an activation phase 130 may take place when the handheld device 34 first joins a cellular network or first connects to a computer or other electronic device 132 via a communication cable 134. During such an activation phase 130, the handheld device 34 or the computer or other device 132 may provide a prompt 136 to initiate voice training. Upon selection of the prompt, a user may initiate the voice training 104.

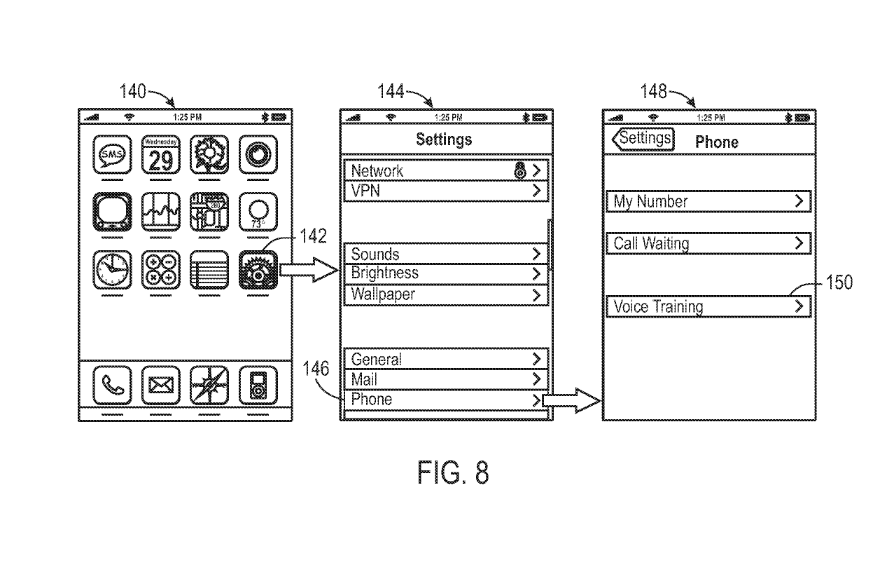

Additionally or alternatively, a voice training sequence 104 may begin when a user selects a setting of the electronic device 10 that causes the electronic device 10 to enter a voice training mode. As shown in FIG. 8, a home screen 140 of the handheld device 34 may include a user-selectable button 142 that, when selected causes the handheld device 34 to display a settings screen 144. When a user selects a user-selectable button 146 labeled “phone” on the settings screen 144, the handheld device 34 may display a phone settings screen 148. The phone settings screen 148 may include, among other things, a user-selectable button 150 labeled “voice training” When a user selects the voice training button 150, a voice training 104 sequence may begin.

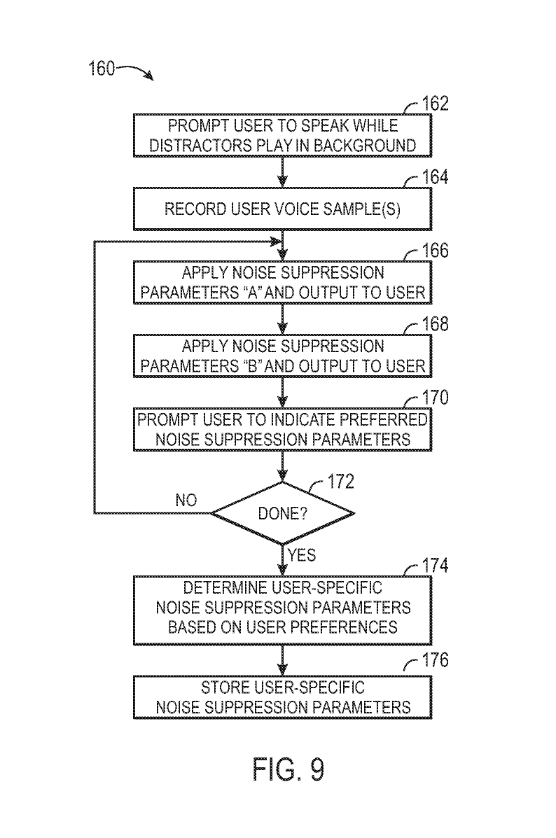

A flowchart 160 of FIG. 9 represents one embodiment of a method for performing the voice training 104. The flowchart 160 may begin when the electronic device 10 prompts the user to speak while certain distractors (e.g., simulated ambient sounds) play in the background (block 162). For example, the user may be asked to speak a certain word or phrase while certain distractors, such as rock music, babbling people, crumpled paper, and so forth, are playing aloud on the computer or other electronic device 132 or on a speaker 48 of the electronic device 10. While such distractors are playing, the electronic device 10 may record a sample of the user's voice (block 164). In some embodiments, blocks 162 and 164 may repeat while a variety of distractors are played to obtain several test audio signals that include both the user's voice and one or more distractors.

To determine which noise suppression parameters a user most prefers, the electronic device 10 may alternatingly apply certain test noise suppression parameters while noise suppression 20 is applied to the test audio signals before requesting feedback from the user. For example, the electronic device 10 may apply a first set of test noise suppression parameters, here labeled “A,” to the test audio signal including the user's voice sample and the one or more distractors, before outputting the audio to the user via a speaker 48 (block 166). Next, the electronic device 10 may apply another set of test noise suppression parameters, here labeled “B,” to the user's voice sample before outputting the audio to the user via the speaker 48 (block 168). The user then may decide which of the two audio signals output by the electronic device 10 the user prefers (e.g., by selecting either “A” or “B” on a display 18 of the electronic device 10) (block 170).

The electronic device 10 may repeat the actions of blocks 166-170 with various test noise suppression parameters and with various distractors, learning more about the user's noise suppression preferences each time until a suitable set of user noise suppression preference data has been obtained (decision block 172). Thus, the electronic device 10 may test the desirability of a variety of noise suppression parameters as actually applied to an audio signal containing the user's voice as well as certain common ambient sounds. In some embodiments, with each iteration of blocks 166-170, the electronic device 10 may “tune” the test noise suppression parameters by gradually varying certain noise suppression parameters (e.g., gradually increasing or decreasing a noise suppression strength) until a user's noise suppression preferences have settled. In other embodiments, the electronic device 10 may test different types of noise suppression parameters in each iteration of blocks 166-170 (e.g., noise suppression strength in one iteration, noise suppression of certain frequencies in another iteration, and so forth). In any case, the blocks 166-170 may repeat until a desired number of user preferences have been obtained (decision block 172).

Based on the indicated user preferences obtained at block(s) 170, the electronic device 10 may develop user-specific noise suppression parameters 102 (block 174). By way of example, the electronic device 10 may arrive at a preferred set of user-specific noise suppression parameters 102 when the iterations of blocks 166-170 have settled, based on the user feedback of block(s) 170. In another example, if the iterations of blocks 166-170 each test a particular set of noise suppression parameters, the electronic device 10 may develop a comprehensive set of user-specific noise suppression parameters based on the indicated preferences to the particular parameters. The user-specific noise suppression parameters 102 may be stored in the memory 14 or the nonvolatile storage 16 of the electronic device 10 (block 176) for noise suppression when the same user later uses a voice-related feature of the electronic device 10.

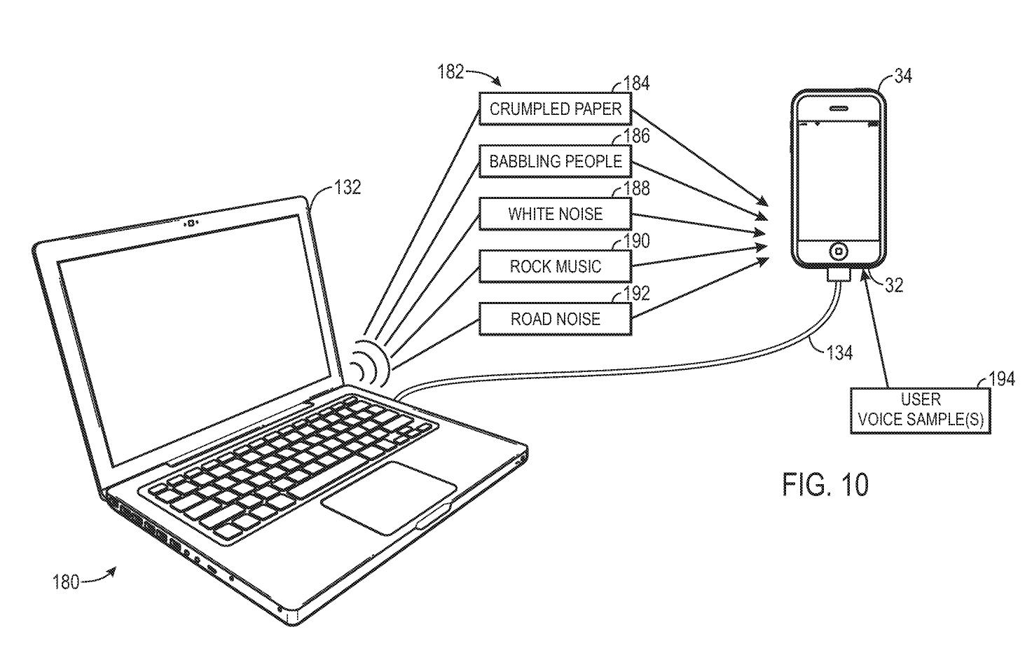

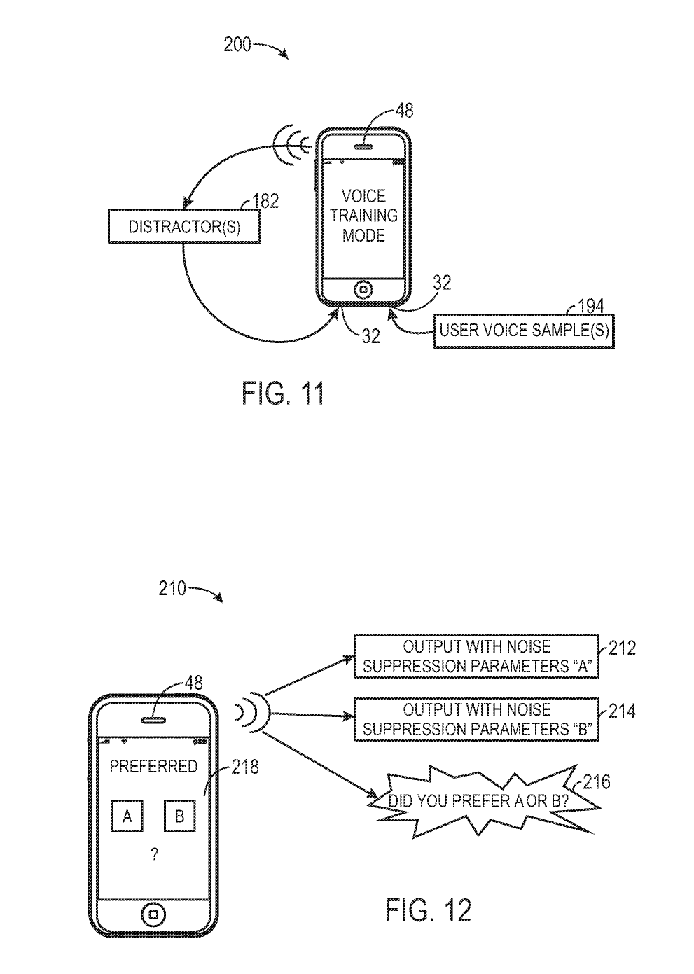

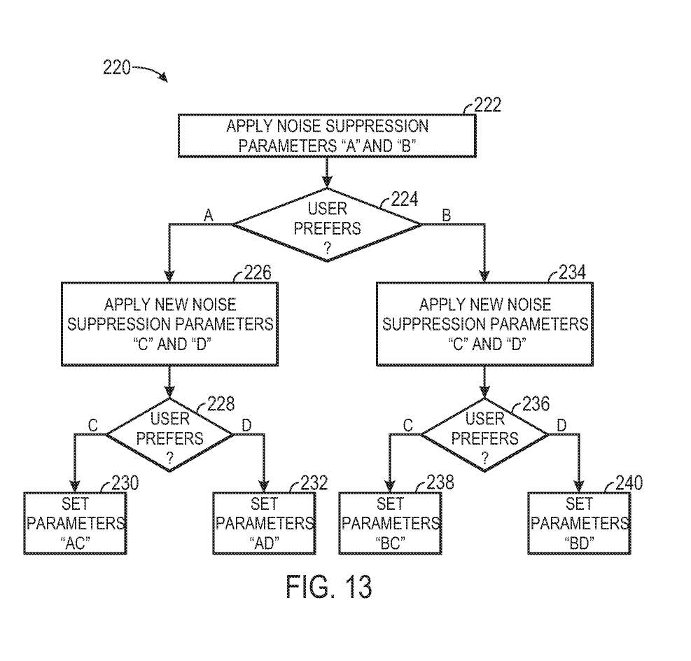

FIGS. 10-13 relate to specific manners in which the electronic device 10 may carry out the flowchart 160 of FIG. 9. In particular, FIGS. 10 and 11 relate to blocks 162 and 164 of the flowchart 160 of FIG. 9, and FIGS. 12 and 13A-B relate to blocks 166-172. Turning to FIG. 10, a dual-device voice recording system 180 includes the computer or other electronic device 132 and the handheld device 34. In some embodiments, the handheld device 34 may be joined to the computer or other electronic device 132 by way of a communication cable 134 or via wireless communication (e.g., an 802.11x Wi-Fi WLAN or a Bluetooth PAN). During the operation of the system 180, the computer or other electronic device 132 may prompt the user to say a word or phrase while one or more of a variety of distractors 182 play in the background. Such distractors 182 may include, for example, sounds of crumpled paper 184, babbling people 186, white noise 188, rock music 190, and/or road noise 192. The distractors 182 may additionally or alternatively include, for example, other noises commonly encountered in various contexts 56, such as those discussed above with reference to FIG. 3. These distractors 182, playing aloud from the computer or other electronic device 132, may be picked up by the microphone 32 of the handheld device 34 at the same time the user provides a user voice sample 194. In this manner, the handheld device 34 may obtain test audio signals that include both a distractor 182 and a user voice sample 194.

In another embodiment, represented by a single-device voice recording system 200 of FIG. 11, the handheld device 34 may both output distractor(s) 182 and record a user voice sample 194 at the same time. As shown in FIG. 11, the handheld device 34 may prompt a user to say a word or phrase for the user voice sample 194. At the same time, a speaker 48 of the handheld device 34 may output one or more distractors 182. The microphone 32 of the handheld device 34 then may record a test audio signal that includes both a currently playing distractor 182 and a user voice sample 194 without the computer or other electronic device 132.

Corresponding to blocks 166-170, FIG. 12 illustrates an embodiment for determining user's noise suppression preferences based on a choice of noise suppression parameters applied to a test audio signal. In particular, the electronic device 10, here represented as the handheld device 34, may apply a first set of noise suppression parameters (“A”) to a test audio signal that includes both a user voice sample 194 and at least one distractor 182. The handheld device 34 may output the noise-suppressed audio signal that results (numeral 212). The handheld device 34 also may apply a second set of noise suppression parameters (“B”) to the test audio signal before outputting the resulting noise-suppressed audio signal (numeral 214).

When the user has heard the result of applying the two sets of noise suppression parameters “A” and “B” to the test audio signal, the handheld device 34 may ask the user, for example, “Did you prefer A or B?” (numeral 216). The user then may indicate a noise suppression preference based on the output noise-suppressed signals. For example, the user may select either the first noise-suppressed audio signal (“A”) or the second noise-suppressed audio signal (“B”) via a screen 218 on the handheld device 34. In some embodiments, the user may indicate a preference in other manners, such as by saying “A” or “B” aloud.

The electronic device 10 may determine the user preferences for specific noise suppression parameters in a variety of manners. A flowchart 220 of FIG. 13 represents one embodiment of a method for performing blocks 166-172 of the flowchart 160 of FIG. 9. The flowchart 220 may begin when the electronic device 10 applies a set of noise suppression parameters that, for exemplary purposes, are labeled “A” and “B”. If the user prefers the noise suppression parameters “A” (decision block 224), the electronic device 10 may next apply new sets of noise suppression parameters that, for similarly descriptive purposes are labeled “C” and “D” (block 226). In certain embodiments, the noise suppression parameters “C” and “D” may be variations of the noise suppression parameters “A.” If a user prefers the noise suppression parameters “C” (decision block 228), the electronic device may set the noise suppression parameters to be a combination of “A” and “C” (block 230). If the user prefers the noise suppression parameters “D” (decision block 228), the electronic device may set the user-specific noise suppression parameters to be a combination of the noise suppression parameters “A” and “D” (block 232).

If, after block 222, the user prefers the noise suppression parameters “B” (decision block 224), the electronic device 10 may apply the new noise suppression parameters “C” and “D” (block 234). In certain embodiments, the new noise suppression parameters “C” and “D” may be variations of the noise suppression parameters “B”. If the user prefers the noise suppression parameters “C” (decision block 236), the electronic device 10 may set the user-specific noise suppression parameters to be a combination of “B” and “C” (block 238). Otherwise, if the user prefers the noise suppression parameters “D”(decision block 236), the electronic device 10 may set the user-specific noise suppression parameters to be a combination of “B” and “D” (block 240). As should be appreciated, the flowchart 220 is presented as only one manner of performing blocks 166-172 of the flowchart 160 of FIG. 9. Accordingly, it should be understood that many more noise suppression parameters may be tested, and such parameters may be tested specifically in conjunction with certain distractors (e.g., in certain embodiments, the flowchart 220 may be repeated for test audio signals that respectively include each of the distractors 182).

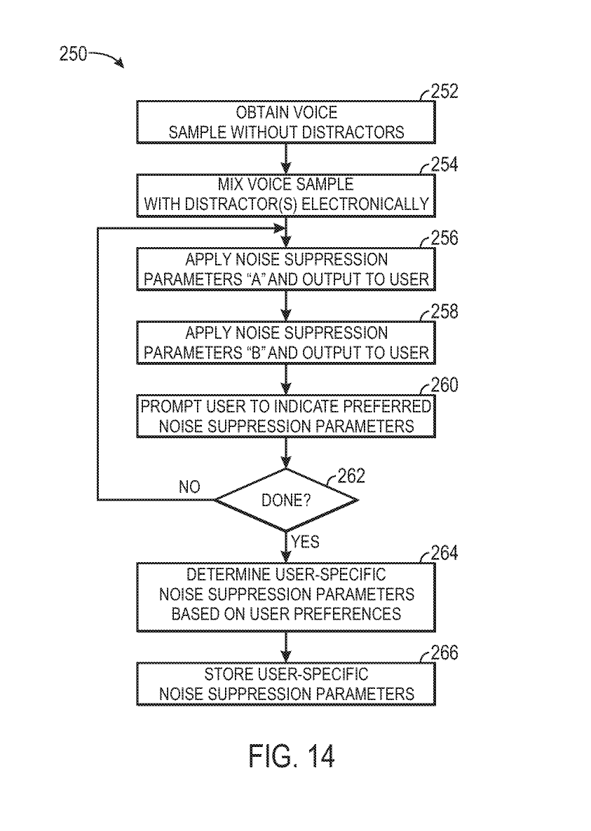

The voice training sequence 104 may be performed in other ways. For example, in one embodiment represented by a flowchart 250 of FIG. 14, a user voice sample 194 first may be obtained without any distractors 182 playing in the background (block 252). In general, such a user voice sample 194 may be obtained in a location with very little ambient sounds 60, such as a quiet room, so that the user voice sample 194 has a relatively high signal-to-noise ratio (SNR). Thereafter, the electronic device 10 may mix the user voice sample 194 with the various distractors 182 electronically (block 254). Thus, the electronic device 10 may produce one or more test audio signals having a variety of distractors 182 using a single user voice sample 194.

Thereafter, the electronic device 10 may determine which noise suppression parameters a user most prefers to determine the user-specific noise suppression parameters 102. In a manner similar to blocks 166-170 of FIG. 9, the electronic device 10 may alternatingly apply certain test noise suppression parameters to the test audio signals obtained at block 254 to gauge user preferences (blocks 256-260). The electronic device 10 may repeat the actions of blocks 256-260 with various test noise suppression parameters and with various distractors, learning more about the user's noise suppression preferences each time until a suitable set of user noise suppression preference data has been obtained (decision block 262). Thus, the electronic device 10 may test the desirability of a variety of noise suppression parameters as applied to a test audio signal containing the user's voice as well as certain common ambient sounds.

Like block 174 of FIG. 9, the electronic device 10 may develop user-specific noise suppression parameters 102 (block 264). The user-specific noise suppression parameters 102 may be stored in the memory 14 or the nonvolatile storage 16 of the electronic device 10 (block 266) for noise suppression when the same user later uses a voice-related feature of the electronic device 10.

As mentioned above, certain embodiments of the present disclosure may involve obtaining a user voice sample 194 without distractors 182 playing aloud in the background. In some embodiments, the electronic device 10 may obtain such a user voice sample 194 the first time that the user uses a voice-related feature of the electronic device 10 in a quiet setting without disrupting the user. As represented in a flowchart 270 of FIG. 15, in some embodiments, the electronic device 10 may obtain such a user voice sample 194 when the electronic device 10 first detects a sufficiently high signal-to-noise ratio (SNR) of audio containing the user's voice.

The flowchart 270 of FIG. 15 may begin when a user is using a voice-related feature of the electronic device 10 (block 272). To ascertain an identity of the user, the electronic device 10 may detect a voice profile of the user based on an audio signal detected by the microphone 32 (block 274). If the voice profile detected in block 274 represents the voice profile of the voice of a known user of the electronic device (decision block 276), the electronic device 10 may apply the user-specific noise suppression parameters 102 associated with that user (block 278). If the user's identity is unknown (decision block 276), the electronic device 10 may initially apply default noise suppression parameters (block 280).

The electronic device 10 may assess the current signal-to-noise ration (SNR) of the audio signal received by the microphone 32 while the voice-related feature is being used (block 282). If the SNR is sufficiently high (e.g., above a preset threshold), the electronic device 10 may obtain a user voice sample 194 from the audio received by the microphone 32 (block 286). If the SNR is not sufficiently high (e.g., below the threshold) (decision block 284), the electronic device 10 may continue to apply the default noise suppression parameters (block 280), continuing to at least periodically reassess the SNR. A user voice sample 194 obtained in this manner may be later employed in the voice training sequence 104 as discussed above with reference to FIG. 14. In other embodiments, the electronic device 10 may employ such a user voice sample 194 to determine the user-specific noise suppression parameters 102 based on the user voice sample 194 itself.

Specifically, in addition to the voice training sequence 104, the user-specified noise suppression parameters 102 may be determined based on certain characteristics associated with a user voice sample 194. For example, FIG. 16 represents a flowchart 290 for determining the user-specific noise suppression parameters 102 based on such user voice characteristics. The flowchart 290 may begin when the electronic device 10 obtains a user voice sample 194 (block 292). The user voice sample may be obtained, for example, according to the flowchart 270 of FIG. 15 or may be obtained when the electronic device 10 prompts the user to say a specific word or phrase. The electronic device next may analyze certain characteristics associated with the user voice sample (block 294).

Based on the various characteristics associated with the user voice sample 194, the electronic device 10 may determine the user-specific noise suppression parameters 102 (block 296). For example, as shown by a voice characteristic diagram 300 of FIG. 17, a user voice sample 194 may include a variety of voice sample characteristics 302. Such characteristics 302 may include, among other things, an average frequency 304 of the user voice sample 194, a variability of the frequency 306 of the user voice sample 194, common speech sounds 308 associated with the user voice sample 194, a frequency range 310 of the user voice sample 194, formant locations 312 in the frequency of the user voice sample, and/or a dynamic range 314 of the user voice sample 194. These characteristics may arise because different users may have different speech patterns. That is, the highness or deepness of a user's voice, a user's accent in speaking, and/or a lisp, and so forth, may be taken into consideration to the extent they change a measurable character of speech, such as the characteristics 302.

As mentioned above, the user-specific noise suppression parameters 102 also may be determined by a direct selection of user settings 108. One such example appears in FIG. 18 as a user setting screen sequence 320 for a handheld device 32. The screen sequence 320 may begin when the electronic device 10 displays a home screen 140 that includes a settings button 142. Selecting the settings button 142 may cause the handheld device 34 to display a settings screen 144. Selecting a user-selectable button 146 labeled “Phone” on the settings screen 144 may cause the handheld device 34 to display a phone settings screen 148, which may include various user-selectable buttons, one of which may be a user-selectable button 322 labeled “Noise Suppression.”

When a user selects the user-selectable button 322, the handheld device 34 may display a noise suppression selection screen 324. Through the noise suppression selection screen 324, a user may select a noise suppression strength. For example, the user may select whether the noise suppression should be high, medium, or low strength via a selection wheel 326. Selecting a higher noise suppression strength may result in the user-specific noise suppression parameters 102 suppressing more ambient sounds 60, but possibly also suppressing more of the voice of the user 58, in a received audio signal. Selecting a lower noise suppression strength may result in the user-specific noise suppression parameters 102 permitting more ambient sounds 60, but also permitting more of the voice of the user 58, to remain in a received audio signal.

In other embodiments, the user may adjust the user-specific noise suppression parameters 102 in real time while using a voice-related feature of the electronic device 10. By way of example, as seen in a call-in-progress screen 330 of FIG. 19, which may be displayed on the handheld device 34, a user may provide a measure of voice phone call quality feedback 332. In certain embodiments, the feedback may be represented by a number of selectable stars 334 to indicate the quality of the call. If the number of stars 334 selected by the user is high, it may be understood that the user is satisfied with the current user-specific noise suppression parameters 102, and so the electronic device 10 may not change the noise suppression parameters. On the other hand, if the number of selected stars 334 is low, the electronic device 10 may vary the user-specific noise suppression parameters 102 until the number of stars 334 is increased, indicating user satisfaction. Additionally or alternatively, the call-in-progress screen 330 may include a real-time user-selectable noise suppression strength setting, such as that disclosed above with reference to FIG. 18.

In certain embodiments, subsets of the user-specific noise suppression parameters 102 may be determined as associated with certain distractors 182 and/or certain contexts 60. As illustrated by a parameter diagram 340 of FIG. 20, the user-specific noise suppression parameters 102 may divided into subsets based on specific distractors 182. For example, the user-specific noise suppression parameters 102 may include distractor-specific parameters 344-352, which may represent noise suppression parameters chosen to filter certain ambient sounds 60 associated with a distractor 182 from an audio signal also including the voice of the user 58. It should be understood that the user-specific noise suppression parameters 102 may include more or fewer distractor-specific parameters. For example, if different distractors 182 are tested during voice training 104, the user-specific noise suppression parameters 102 may include different distractor-specific parameters.

The distractor-specific parameters 344-352 may be determined when the user-specific noise suppression parameters 102 are determined. For example, during voice training 104, the electronic device 10 may test a number of noise suppression parameters using test audio signals including the various distractors 182. Depending on a user's preferences relating to noise suppression for each distractor 182, the electronic device may determine the distractor-specific parameters 344-352. By way of example, the electronic device may determine the parameters for crumpled paper 344 based on a test audio signal that included the crumpled paper distractor 184. As described below, the distractor-specific parameters of the parameter diagram 340 may later be recalled in specific instances, such as when the electronic device 10 is used in the presence of certain ambient sounds 60 and/or in certain contexts 56.

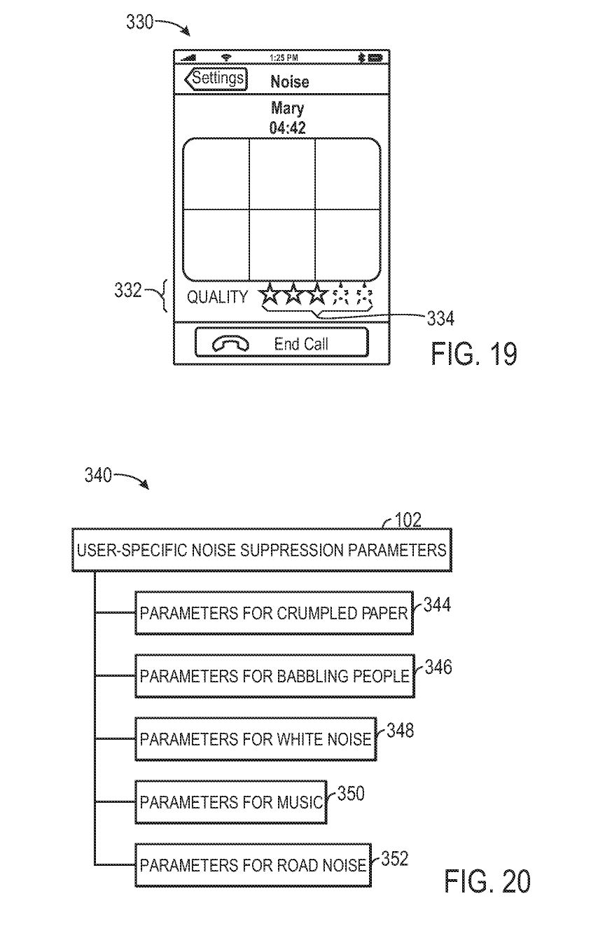

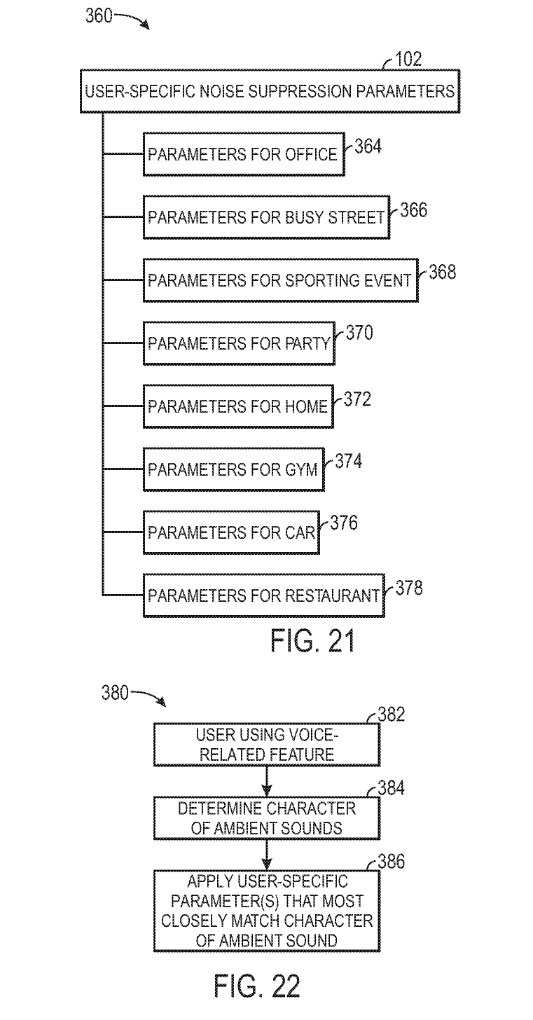

Additionally or alternatively, subsets of the user-specific noise suppression parameters 102 may be defined relative to certain contexts 56 where a voice-related feature of the electronic device 10 may be used. For example, as represented by a parameter diagram 360 shown in FIG. 21, the user-specific noise suppression parameters 102 may be divided into subsets based on which context 56 the noise suppression parameters may best be used. For example, the user-specific noise suppression parameters 102 may include context-specific parameters 364-378, representing noise suppression parameters chosen to filter certain ambient sounds 60 that may be associated with specific contexts 56. It should be understood that the user-specific noise suppression parameters 102 may include more or fewer context-specific parameters. For example, as discussed below, the electronic device 10 may be capable of identifying a variety of contexts 56, each of which may have specific expected ambient sounds 60. The user-specific noise suppression parameters 102 therefore may include different context-specific parameters to suppress noise in each of the identifiable contexts 56.

Like the distractor-specific parameters 344-352, the context-specific parameters 364-378 may be determined when the user-specific noise suppression parameters 102 are determined. To provide one example, during voice training 104, the electronic device 10 may test a number of noise suppression parameters using test audio signals including the various distractors 182. Depending on a user's preferences relating to noise suppression for each distractor 182, the electronic device 10 may determine the context-specific parameters 364-378.

The electronic device 10 may determine the context-specific parameters 364-378 based on the relationship between the contexts 56 of each of the context-specific parameters 364-378 and one or more distractors 182. Specifically, it should be noted that each of the contexts 56 identifiable to the electronic device 10 may be associated with one or more specific distractors 182. For example, the context 56 of being in a car 70 may be associated primarily with one distractor 182, namely, road noise 192. Thus, the context-specific parameters 376 for being in a car may be based on user preferences related to test audio signals that included road noise 192. Similarly, the context 56 of a sporting event 72 may be associated with several distractors 182, such as babbling people 186, white noise 188, and rock music 190. Thus, the context-specific parameters 368 for a sporting event may be based on a combination of user preferences related to test audio signals that included babbling people 186, white noise 188, and rock music 190. This combination may be weighted to more heavily account for distractors 182 that are expected to more closely match the ambient sounds 60 of the context 56.

As mentioned above, the user-specific noise suppression parameters 102 may be determined based on characteristics of the user voice sample 194 with or without the voice training 104 (e.g., as described above with reference to FIGS. 16 and 17). Under such conditions, the electronic device 10 may additionally or alternatively determine the distractor-specific parameters 344-352 and/or the context-specific parameters 364-378 automatically (e.g., without user prompting). These noise suppression parameters 344-352 and/or 363-378 may be determined based on the expected performance of such noise suppression parameters when applied to the user voice sample 194 and certain distractors 182.

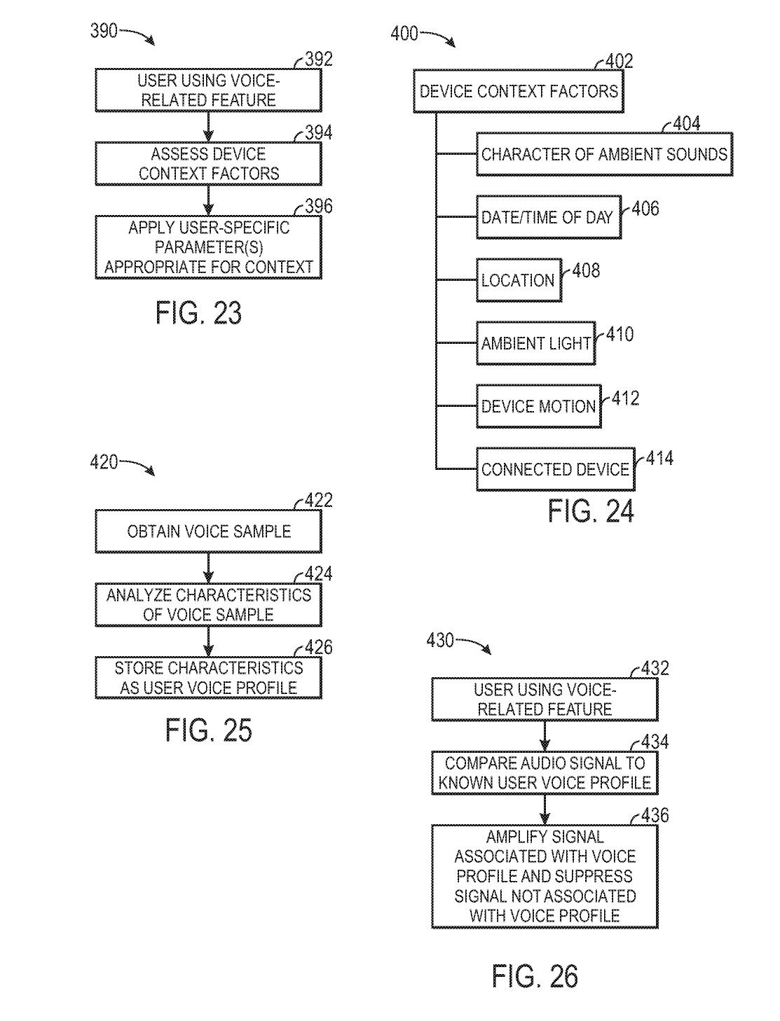

When a voice-related feature of the electronic device 10 is in use, the electronic device 10 may tailor the noise suppression 20 both to the user and to the character of the ambient sounds 60 using the distractor-specific parameters 344-352 and/or the context-specific parameters 364-378. Specifically, FIG. 22 illustrates an embodiment of a method for selecting and applying the distractor-specific parameters 344-352 based on the assessed character of ambient sounds 60. FIG. 23 illustrates an embodiment of a method for selecting and applying the context-specific parameters 364-378 based on the identified context 56 where the electronic device 10 is used.

Turning to FIG. 22, a flowchart 380 for selecting and applying the distractor-specific parameters 344-352 may begin when a voice-related feature of the electronic device 10 is in use (block 382). Next, the electronic device 10 may determine the character of the ambient sounds 60 received by its microphone 32 (block 384). In some embodiments, the electronic device 10 may differentiate between the ambient sounds 60 and the user's voice 58, for example, based on volume level (e.g., the user's voice 58 generally may be louder than the ambient sounds 60) and/or frequency (e.g., the ambient sounds 60 may occur outside of a frequency range associated with the user's voice 58).

The character of the ambient sounds 60 may be similar to one or more of the distractors 182. Thus, in some embodiments, the electronic device 10 may apply the one of the distractor-specific parameters 344-352 that most closely match the ambient sounds 60 (block 386). For the context 56 of being at a restaurant 74, for example, the ambient sounds 60 detected by the microphone 32 may most closely match babbling people 186. The electronic device 10 thus may apply the distractor-specific parameter 346 when such ambient sounds 60 are detected. In other embodiments, the electronic device 10 may apply several of the distractor-specific parameters 344-352 that most closely match the ambient sounds 60. These several distractor-specific parameters 344-352 may be weighted based on the similarity of the ambient sounds 60 to the corresponding distractors 182. For example, the context 56 of a sporting event 72 may have ambient sounds 60 similar to several distractors 182, such as babbling people 186, white noise 188, and rock music 190. When such ambient sounds 60 are detected, the electronic device 10 may apply the several associated distractor-specific parameters 346, 348, and/or 350 in proportion to the similarity of each to the ambient sounds 60.

In a similar manner, the electronic device 10 may select and apply the context-specific parameters 364-378 based on an identified context 56 where the electronic device 10 is used. Turning to FIG. 23, a flowchart 390 for doing so may begin when a voice-related feature of the electronic device 10 is in use (block 392). Next, the electronic device 10 may determine the current context 56 in which the electronic device 10 is being used (block 394). Specifically, the electronic device 10 may consider a variety of device context factors (discussed in greater detail below with reference to FIG. 24). Based on the context 56 in which the electronic device 10 is determined to be in use, the electronic device 10 may apply the associated one of the context-specific parameters 364-378 (block 396).

As shown by a device context factor diagram 400 of FIG. 24, the electronic device 10 may consider a variety of device context factors 402 to identify the current context 56 in which the electronic device 10 is being used. These device context factors 402 may be considered alone or in combination in various embodiments and, in some cases, the device context factors 402 may be weighted. That is, device context factors 402 more likely to correctly predict the current context 56 may be given more weight in determining the context 56, while device context factors 402 less likely to correctly predict the current context 56 may be given less weight.

For example, a first factor 404 of the device context factors 402 may be the character of the ambient sounds 60 detected by the microphone 32 of the electronic device 10. Since the character of the ambient sounds 60 may relate to the context 56, the electronic device 10 may determine the context 56 based at least partly on such an analysis.

A second factor 406 of the device context factors 402 may be the current date or time of day. In some embodiments, the electronic device 10 may compare the current date and/or time with a calendar feature of the electronic device 10 to determine the context. By way of example, if the calendar feature indicates that the user is expected to be at dinner, the second factor 406 may weigh in favor of determining the context 56 to be a restaurant 74. In another example, since a user may be likely to commute in the morning or late afternoon, at such times the second factor 406 may weigh in favor of determining the context 56 to be a car 70.

A third factor 408 of the device context factors 402 may be the current location of the electronic device 10, which may be determined by the location-sensing circuitry 22. Using the third factor 408, the electronic device 10 may consider its current location in determining the context 56 by, for example, comparing the current location to a known location in a map feature of the electronic device 10 (e.g., a restaurant 74 or office 64) or to locations where the electronic device 10 is frequently located (which may indicate, for example, an office 64 or home 62).

A fourth factor 410 of the device context factors 402 may be the amount of ambient light detected around the electronic device 10 via, for example, the image capture circuitry 28 of the electronic device. By way of example, a high amount of ambient light may be associated with certain contexts 56 located outdoors (e.g., a busy street 68). Under such conditions, the factor 410 may weigh in favor of a context 56 located outdoors. A lower amount of ambient light, by contrast, may be associated with certain contexts 56 located indoors (e.g., home 62), in which case the factor 410 may weigh in favor of such an indoor context 56.

A fifth factor 412 of the device context factors 402 may be detected motion of the electronic device 10. Such motion may be detected based on the accelerometers and/or magnetometer 30 and/or based on changes in location over time as determined by the location-sensing circuitry 22. Motion may suggest a given context 56 in a variety of ways. For example, when the electronic device 10 is detected to be moving very quickly (e.g., faster than 20 miles per hour), the factor 412 may weigh in favor of the electronic device 10 being in a car 70 or similar form of transportation. When the electronic device 10 is moving randomly, the factor 412 may weigh in favor of contexts in which a user of the electronic device 10 may be moving about (e.g., at a gym 66 or a party 76). When the electronic device 10 is mostly stationary, the factor 412 may weigh in favor of contexts 56 in which the user is seated at one location for a period of time (e.g., an office 64 or restaurant 74).

A sixth factor 414 of the device context factors 402 may be a connection to another device (e.g., a Bluetooth handset). For example, a Bluetooth connection to an automotive hands-free phone system may cause the sixth factor 414 to weigh in favor of determining the context 56 to be in a car 70.

In some embodiments, the electronic device 10 may determine the user-specific noise suppression parameters 102 based on a user voice profile associated with a given user of the electronic device 10. The resulting user-specific noise suppression parameters 102 may cause the noise suppression 20 to isolate ambient sounds 60 that do not appear associated with the user voice profile, and thus may be understood to likely be noise. FIGS. 25-29 relate to such techniques.

As shown in FIG. 25, a flowchart 420 for obtaining a user voice profile may begin when the electronic device 10 obtains a voice sample (block 422). Such a voice sample may be obtained in any of the manners described above. The electronic device 10 may analyze certain of the characteristics of the voice sample, such as those discussed above with reference to FIG. (block 424). The specific characteristics may be quantified and stored as a voice profile of the user (block 426). The determined user voice profile may be employed to tailor the noise suppression 20 to the user's voice, as discussed below. In addition, the user voice profile may enable the electronic device 10 to identify when a particular user is using a voice-related feature of the electronic device 10, such as discussed above with reference to FIG. 15.

With such a voice profile, the electronic device 10 may perform the noise suppression 20 in a manner best applicable to that user's voice. In one embodiment, as represented by a flowchart 430 of FIG. 26, the electronic device 10 may suppress frequencies of an audio signal that more likely correspond to ambient sounds 60 than a voice of a user 58, while enhancing frequencies more likely to correspond to the voice signal 58. The flowchart 430 may begin when a user is using a voice-related feature of the electronic device 10 (block 432). The electronic device 10 may compare an audio signal received that includes both a user voice signal 58 and ambient sounds 60 to a user voice profile associated with the user currently speaking into the electronic device 10 (block 434). To tailor the noise suppression 20 to the user's voice, the electronic device may perform noise suppression 20 in a manner that suppresses frequencies of the audio signal that are not associated with the user voice profile and by amplifying frequencies of the audio signal that are associated with the user voice profile (block 436).

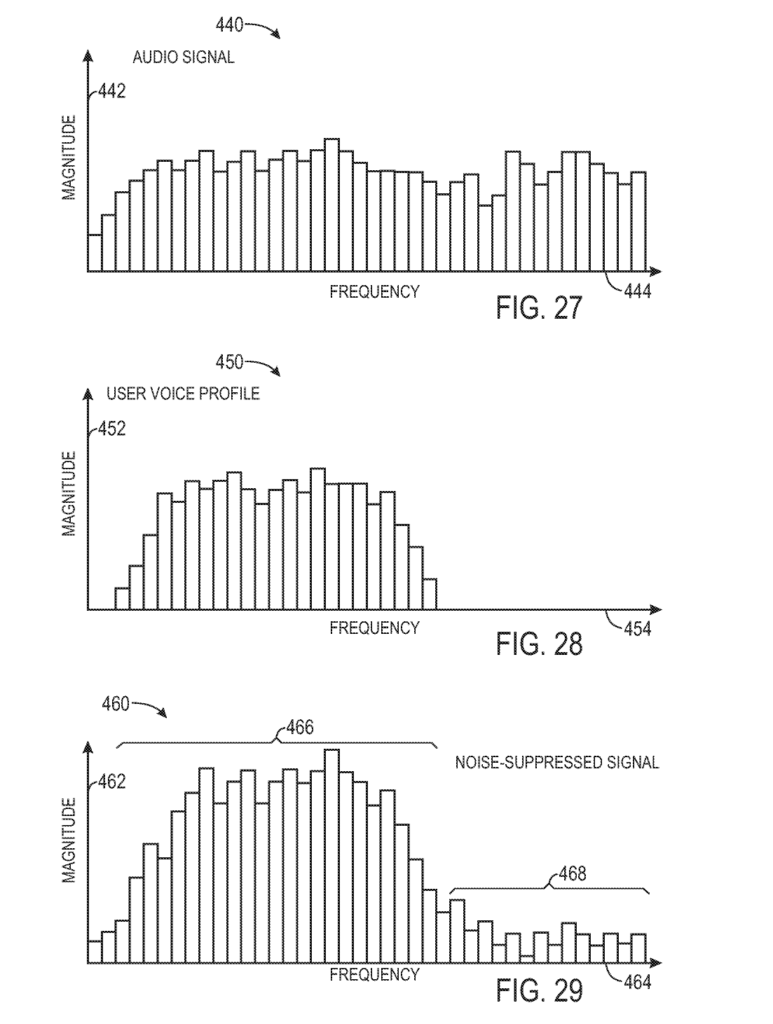

One manner of doing so is shown through FIGS. 27-29, which represent plots modeling an audio signal, a user voice profile, and an outgoing noise-suppressed signal. Turning to FIG. 27, a plot 440 represents an audio signal that has been received into the microphone 32 of the electronic device 10 while a voice-related feature is in use and transformed into the frequency domain. An ordinate 442 represents a magnitude of the frequencies of the audio signal and an abscissa 444 represents various discrete frequency components of the audio signal. It should be understood that any suitable transform, such as a fast Fourier transform (FFT), may be employed to transform the audio signal into the frequency domain. Similarly, the audio signal may be divided into any suitable number of discrete frequency components (e.g., 40, 128, 256, etc.).

By contrast, a plot 450 of FIG. 28 is a plot modeling frequencies associated with a user voice profile. An ordinate 452 represents a magnitude of the frequencies of the user voice profile and an abscissa 454 represents discrete frequency components of the user voice profile. Comparing the audio signal plot 440 of FIG. 27 to the user voice profile plot 450 of FIG. 28, it may be seen that the modeled audio signal includes range of frequencies not typically associated with the user voice profile. That is, the modeled audio signal may be likely to include other ambient sounds 60 in addition to the user's voice.

From such a comparison, when the electronic device 10 carries out noise suppression 20, it may determine or select the user-specific noise suppression parameters 102 such that the frequencies of the audio signal of the plot 440 that correspond to the frequencies of the user voice profile of the plot 450 are generally amplified, while the other frequencies are generally suppressed. Such a resulting noise-suppressed audio signal is modeled by a plot 460 of FIG. 29. An ordinate 462 of the plot 460 represents a magnitude of the frequencies of the noise-suppressed audio signal and an abscissa 464 represents discrete frequency components of the noise-suppressed signal. An amplified portion 466 of the plot 460 generally corresponds to the frequencies found in the user voice profile. By contrast, a suppressed portion 468 of the plot 460 corresponds to frequencies of the noise-suppressed signal that are not associated with the user profile of plot 450. In some embodiments, a greater amount of noise suppression may be applied to frequencies not associated with the user voice profile of plot 450, while a lesser amount of noise suppression may be applied to the portion 466, which may or may not be amplified.

The above discussion generally focused on determining the user-specific noise suppression parameters 102 for performing the TX NS 84 of the noise suppression 20 on an outgoing audio signal, as shown in FIG. 4. However, as mentioned above, the user-specific noise suppression parameters 102 also may be used for performing the RX NS 92 on an incoming audio signal from another device. Since such an incoming audio signal from another device will not include the user's own voice, in certain embodiments, the user-specific noise suppression parameters 102 may be determined based on voice training 104 that involves several test voices in addition to several distractors 182.

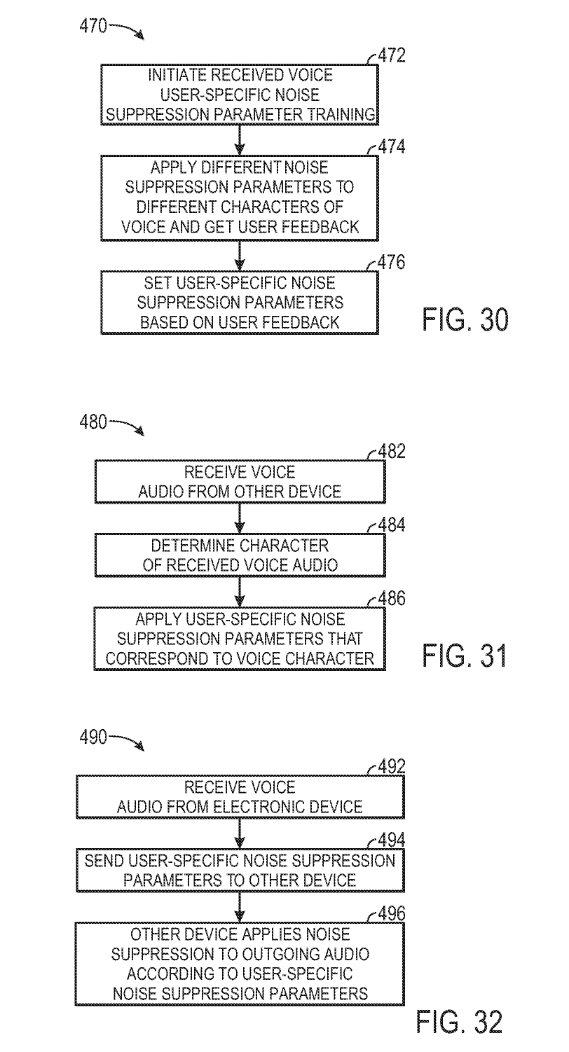

For example, as presented by a flowchart 470 of FIG. 30, the electronic device 10 may determine the user-specific noise suppression parameters 102 via voice training 104 involving pre-recorded or simulated voices and simulated distractors 182. Such an embodiment of the voice training 104 may involve test audio signals that include a variety of difference voices and distractors 182. The flowchart 470 may begin when a user initiates voice training 104 (block 472). Rather than perform the voice training 104 based solely on the user's own voice, the electronic device 10 may apply various noise suppression parameters to various test audio signals containing various voices, one of which may be the user's voice in certain embodiments (block 474). Thereafter, the electronic device 10 may ascertain the user's preferences for different noise suppression parameters tested on the various test audio signals. As should be appreciated, block 474 may be carried out in a manner similar to blocks 166-170 of FIG. 9.

Based on the feedback from the user at block 474, the electronic device 10 may develop user-specific noise suppression parameters 102 (block 476). The user-specific parameters 102 developed based on the flowchart 470 of FIG. 30 may be well suited for application to a received audio signal (e.g., used to form the RX NS parameters 94, as shown in FIG. 4). In particular, a received audio signal will includes different voices when the electronic device 10 is used as a telephone by a “near-end” user to speak with “far-end” users. Thus, as shown by a flowchart 480 of FIG. 31, the user-specific noise suppression parameters 102, determined using a technique such as that discussed with reference to FIG. 30, may be applied to the received audio signal from a far-end user depending on the character of the far-end user's voice in the received audio signal.

The flowchart 480 may begin when a voice-related feature of the electronic device 10, such as a telephone or chat feature, is in use and is receiving an audio signal from another electronic device 10 that includes a far-end user's voice (block 482). Subsequently, the electronic device 10 may determine the character of the far-end user's voice in the audio signal (block 484). Doing so may entail, for example, comparing the far-end user's voice in the received audio signal with certain other voices that were tested during the voice training 104 (when carried out as discussed above with reference to FIG. 30). The electronic device 10 next may apply the user-specific noise suppression parameters 102 that correspond to one of the other voices that is most similar to the end-user's voice (block 486).

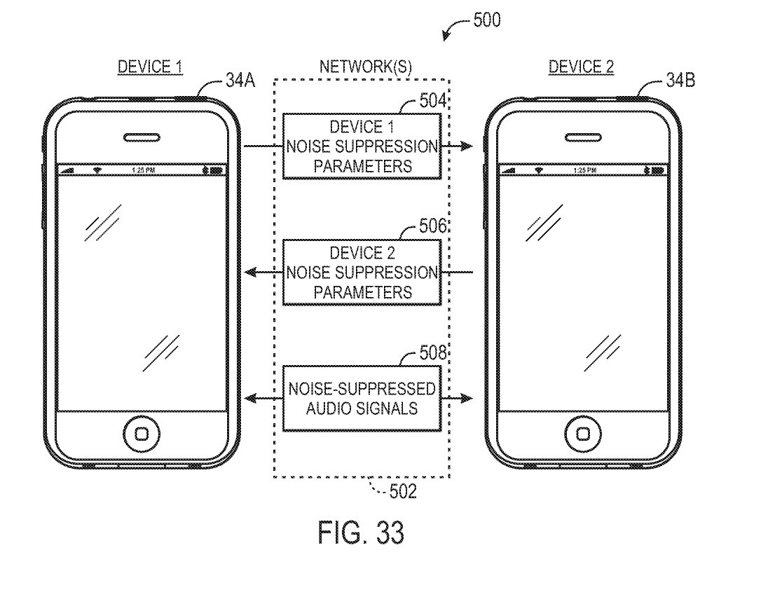

In general, when a first electronic device 10 receives an audio signal containing a far-end user's voice from a second electronic device 10 during two-way communication, such an audio signal already may have been processed for noise suppression in the second electronic device 10. According to certain embodiments, such noise suppression in the second electronic device 10 may be tailored to the near-end user of the first electronic 10, as described by a flowchart 490 of FIG. 32. The flowchart 490 may begin when the first electronic device 10 (e.g., handheld device 34A of FIG. 33) is or is about to begin receiving an audio signal of the far-end user's voice from the second electronic device 10 (e.g., handheld device 34B) (block 492). The first electronic device 10 may transmit the user-specific noise suppression parameters 102, previously determined by the near-end user, to the second electronic device 10 (block 494). Thereafter, the second electronic device 10 may apply those user-specific noise suppression parameters 102 toward the noise suppression of the far-end user's voice in the outgoing audio signal (block 496). Thus, the audio signal including the far-end user's voice that is transmitted from the second electronic device 10 to the first electronic device 10 may have the noise-suppression characteristics preferred by the near-end user of the first electronic device 10.

The above-discussed technique of FIG. 32 may be employed systematically using two electronic devices 10, illustrated as a system 500 of FIG. 33 including handheld devices 34A and 34B with similar noise suppression capabilities. When the handheld devices 34A and 34B are used for intercommunication by a near-end user and a far-end user respectively over a network (e.g., using a telephone or chat feature), the handheld devices 34A and 34B may exchange the user-specific noise suppression parameters 102 associated with their respective users (blocks 504 and 506). That is, the handheld device 34B may receive the user-specific noise suppression parameters 102 associated with the near-end user of the handheld device 34A. Likewise, the handheld device 34A may receive the user-specific noise suppression parameters 102 associated with the far-end user of the handheld device 34B. Thereafter, the handheld device 34A may perform noise suppression 20 on the near-end user's audio signal based on the far-end user's user-specific noise suppression parameters 102. Likewise, the handheld device 34B may perform noise suppression 20 on the far-end user's audio signal based on the near-end user's user-specific noise suppression parameters 102. In this way, the respective users of the handheld devices 34A and 34B may hear audio signals from the other whose noise suppression matches their respective preferences.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A method, comprising:
at an electronic device with one or more processors and memory:
receiving an audio signal that includes a user voice of the electronic device when a voice-related feature of the electronic device is in use; and
suppressing noise in the audio signal while substantially preserving the user voice based at least in part on user-specific noise suppression parameters using the electronic device, wherein the user-specific noise suppression parameters are based at least in part on a user noise suppression preference or a user voice profile, or a combination thereof.

2. The method of claim 1, wherein the user noise suppression preference is based at least in part on a user noise suppression training sequence.

3. The method of claim 2, wherein the user noise suppression training sequence comprises receiving in the electronic device a user selection of preferred noise parameters after noise suppression parameters have been tested on a test audio signal and played back to the user.

4. The method of claim 2, wherein the user noise suppression training sequence comprises testing noise suppression parameters as applied to a test audio signal that includes a user voice sample and at least one distractor.

5. The method of claim 1, wherein the user noise suppression preference is based at least in part on a user-selected noise suppression setting.

6. The method of claim 5, wherein the user-selected noise suppression setting comprises a noise suppression strength setting.

7. The method of claim 5, wherein the user-selected noise suppression setting is user-selectable in real time while the voice-related feature of the electronic device is in use.

8. The method of claim 1, wherein the user-specific noise suppression parameters suppress noise in the audio signal while substantially preserving the user voice at least in part by amplifying frequencies associated with the user voice profile.

9. The method of claim 1, wherein the user-specific noise suppression parameters suppress noise in the audio signal while substantially preserving the user voice at least in part by suppressing frequencies not associated with the user voice profile.

10. An electronic device, comprising:
one or more processors;
one or more microphones; and
memory storing one or more programs for execution by the at least one processor, the one or more programs including instructions for:
receiving an audio signal that includes a user voice of the electronic device when a voice-related feature of the electronic device is in use; and
suppressing noise in the audio signal while substantially preserving the user voice based at least in part on user-specific noise suppression parameters using the electronic device, wherein the user-specific noise suppression parameters are based at least in part on a user noise suppression preference or a user voice profile, or a combination thereof.

11. A non-transitory computer-readable storage medium, storing one or more programs for execution by one or more processors of an electronic device, the one or more programs including instructions for:
receiving an audio signal that includes a user voice of the electronic device when a voice-related feature of the electronic device is in use; and
suppressing noise in the audio signal while substantially preserving the user voice based at least in part on user-specific noise suppression parameters using the electronic device, wherein the user-specific noise suppression parameters are based at least in part on a user noise suppression preference or a user voice profile, or a combination thereof.

12. An electronic device, comprising:
one or more processors;
one or more microphones; and
memory storing one or more programs for execution by the at least one processor, the one or more programs including instructions for:
obtaining an audio signal that includes a user voice and ambient sounds;
noise suppression circuitry configured to apply noise suppression to the audio signal based at least in part on user-specific noise suppression parameters to suppress the ambient sounds of the audio signal; and
data processing circuitry configured to provide the user-specific noise suppression parameters, wherein the data processing circuitry is configured to determine the user-specific noise suppression parameters based at least in part on a user voice profile associated with the user voice.

13. The electronic device of claim 12, wherein the one or more programs further include instructions for:
determining the user voice profile based at least in part on a user voice sample, wherein the microphone is configured to obtain the user voice sample during an activation period of the electronic device.

14. The electronic device of claim 12, wherein the one or more programs further include instructions for:
determining the user voice profile based at least in part on a user voice sample; and
wherein the one or more microphones are configured to:
obtain the user voice sample by monitoring a signal-to-noise ratio of another audio signal obtained while a voice-related feature of the electronic device is in use; and
record the other audio signal when the signal-to-noise ratio of the other audio signal exceeds a threshold.

15. The electronic device of claim 12, wherein the one or more programs further include instructions for:
determining whether the user voice corresponds to a known user and, when the user voice corresponds to the known user, recalling the user voice profile associated with the user voice.

16. The electronic device of claim 12, wherein the one or more programs further include instructions for:
determining whether the user voice corresponds to a known user and, when the user voice does not correspond to the known user, determining the user voice profile associated with the user voice by obtaining a user voice sample and determining the user voice profile based at least in part on the user voice sample.
